(19) United States
(12) Patent Application Publication
(10) Pub. No.: US 2026/0113415 A1
(43) Pub. Date: Apr. 23, 2026

(54) AVATAR GENERATION FROM RECENT IMAGE

(71) Applicant: Lenovo Global Technology (United States) Inc., Morrisville, NC (US)

(72) Inventors: Mark Delaney, Raleigh, NC (US); Nathan Peterson, Oxford, NC (US); John C. Mese, Cary, NC (US); Diana Gerli, Raleigh, NC (US)

(21) Appl. No.: 18/921,708

(22) Filed: Oct. 21, 2024

(51) Int. Cl. H04N 7/15; G06T 17/00

(52) U.S. Cl. CPC H04N 7/157; G06T 17/00

(57) ABSTRACT

One embodiment provides a method, the method including: identifying, using an avatar generation system, that a user is accessing a software platform that supports display of an avatar to represent the user; obtaining, using the avatar generation system, an image of the user, wherein a time associated with a capture of the image is within a predetermined time frame as compared to a time of the identifying; and generating, from the image and before the user enters into a session of the software platform, an avatar to represent the user within the software platform. Other aspects are claimed and described.

### BACKGROUND

Many companies support or allow remote workers. Additionally, many companies have locations that are geographically diverse. For example, a company may have a building or department that is located at a different physical geographical location as compared to another building or department. These geographically diverse locations can even include locations that are in different countries as compared to each other. Additionally, many companies or individuals may need to communicate with other companies or individuals that are located in a different physical location. Thus, it can be difficult for all employees or people who need to communicate to be in the same physical location. While a telephone or conference call may be useful or sufficient for some communications, they are not always sufficient or the most desirable communication medium. Thus, video conferencing or video calls has become more prevalent for communications where people on the call might be in physically disparate locations.

The advantage to a video conference or a video call is that individuals can see visuals that may be presented by other individuals on the video conference or video call. However, the ability to present a visual also comes with the inclusion of a video feed for all participants on the video conference or video call, even if the participant is not actually presenting any visual information within the video feed. Thus, one default is that a video feed of the individual or participant is presented. In other words, if a participant is not presenting visual information (e.g., screen share, video feed of an object, etc.), one typical default is that a video feed of the individual or participant is presented. However, individuals or participants may not want to transmit a video feed of themselves, for one reason or another. Thus, video conferencing or video call software does normally allow the individual or participant to turn off the video feed.

### BRIEF SUMMARY

In summary, one aspect provides a method, the method including: identifying, using an avatar generation system, that a user is accessing a software platform that supports display of an avatar to represent the user; obtaining, using the avatar generation system, an image of the user, wherein a time associated with a capture of the image is within a predetermined time frame as compared to a time of the identifying; and generating, from the image and before the user enters into a session of the software platform, an avatar to represent the user within the software platform.

Another aspect provides a system, the system including: a processor; a memory device that stores instructions that, when executed by the processor, causes the system to: identify, using an avatar generation system, that a user is accessing a software platform that supports display of an avatar to represent the user; obtain, using the avatar generation system, an image of the user, wherein a time associated with a capture of the image is within a predetermined time frame as compared to a time of the identifying; and generate, from the image and before the user enters into a session of the software platform, an avatar to represent the user within the software platform.

A further aspect provides a product, the product including: a computer-readable storage device that stores executable code that, when executed by a processor, causes the product to: identify, using an avatar generation system, that a user is accessing a software platform that supports display of an avatar to represent the user; obtain, using the avatar generation system, an image of the user, wherein a time associated with a capture of the image is within a predetermined time frame as compared to a time of the identifying; and generate, from the image and before the user enters into a session of the software platform, an avatar to represent the user within the software platform.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for generating an avatar to represent a user within a software platform using a recent image of the user.

### DETAILED DESCRIPTION

When the video feed is turned off in video conferencing or video call software, a couple of different static images may be presented in place of the video feed of the individual or participant. One type of static image is simply some visual object that is associated with the participant, but is not necessarily representative of the participant, for example, a static letter or set of letters that are associated with an identifier of the participant. The participant can also upload an image to be used for the participant when the video feed is muted or turned off. This image may or may not be of the participant. However, even if the user selects an image of themselves, such an image selection does not remain representative of the user since the appearance of the user can change over time and may change frequently.

The user can also create an avatar intended to be representative of the user. These types of avatars can be configured by the user, where the user is able to select different characteristics of the avatar in an effort to make the avatar look more like the user. For example, the user can select a hair style and a hair color, different eye configurations and colors, facial hair, and/or the like, for the avatar. However, whether this avatar accurately represents the user is dependent upon the different configuration choices available to the user and also the selections made by the user. Additionally, once configured, the avatar does not change unless the user makes changes to the avatar, which may not be something the user does very frequently. However, the advantage to these static images or avatars is that the user can keep their image capture device off during the software platform session. Thus, these techniques are not very intrusive and the user does not have to worry about what is displayed in a video feed if the image capture device where to be turned on.

Instead of a static image, the software platform may also display or present a dynamic representation of the individual or participant that is different than a video feed of the participant. Instead of a direct video feed of the user, some software platforms will present a video feed of an avatar of the participant. In this scenario, the participant keeps the image capture device on during the conference session and the image capture device captures a video of the user. However, instead of directly providing the video of the user within the video feed, the system first changes the participant within the video to an avatar. The video feed is then of the avatar instead of the direct video of the participant. However, the avatar moves as the user moves in the underlying video that is being captured. In other words, the avatar that is presented is a real-time avatar representation of the participant while the user is participating in the session of the software platform.

This dynamic representation of the participant as an avatar requires the image capture device of the user to remain on, which makes this technique intrusive. Additionally, such systems rely on the real-time generation of the avatar filter, which means that if the avatar filter system fails the identity of the user is revealed. The real-time generation of the avatar filter is susceptible to failing because it will fail when the rigging on the participant is lost. Rigging involves adding a virtual skeleton to a 3D model to allow animation of facial expressions and movement. Movement of the user causes a loss of rigging to be more likely. Thus, these avatar filter methods end up being fairly intrusive because it requires the image capture device to remain on during the session of the software platform and can reveal the identity and environment of the user if the filter fails. The most representative option is to keep the image capture device on during the session and include a video feed of the user themselves. However, this option is the most intrusive and results in the least privacy for the user.

Accordingly, the described system and method provides a technique for generating an avatar to represent a user within a software platform using a recent image of the user. The system identifies that a user is accessing a software platform that supports the display of an avatar to represent the user. While the example of a video conference or video call software platform is described herein, this is merely used as an example software platform. Many other software platforms support the use of an avatar to represent a user. For example, in many gaming software platforms, the user is represented by an avatar. Other software platforms that typically support the use of an avatar to represent a user include, but are not limited to, virtual reality software platforms, augmented reality software platforms, social media software platforms, messaging software platforms, and/or the like. Thus, while a video conferencing software platform will be used here throughout, this is not intended to be limiting as the described system and method can be utilized in any software platform where an avatar can be or could be utilized, either currently or in the future.

Upon identifying that the user is accessing the software platform, the avatar generation system obtains an image of the user. The system is attempting to represent the user and any changes in appearances of the user. Accordingly, the system attempts to obtain an image (or set of images) that is within a predetermined time frame as compared to when the user is accessing the software platform. In other words, the system is attempting to obtain a “recent” image or set of images of the user. A recent image is one that was captured within the predetermined time frame. The predetermined time frame can vary between users, between systems, be configured by a user, be learned by the system, be based upon a characteristic of the user, and/or the like. Thus, whether an image (or set of images) is considered recent can vary between users or software platform accesses. It should be noted that while a single image will be discussed herein for ease of readability, the system may obtain more than one image. Thus, “an image” should be construed to include one or more images. The system can dynamically update the avatar as the recency period for a previously created avatar expires or as an appearance of the user changes.

From the image(s) and before the user enters or is placed into a session of the software platform, the system generates an avatar to represent the user within the software platform. It should be noted that the avatar is generated before the user is placed within the session of the software platform. In other words, rather than utilizing an avatar filter that requires the user to maintain the activation of the image capture device during the software platform session, the system is able to generate the avatar before the user enters or is placed into the software platform session, thereby allowing the user to deactivate the image capture device during the software platform session.

Therefore, a system provides a technical improvement over traditional methods for representing users within a software session. Instead of using static images that may not represent the user at all or that may not accurately represent a current appearance of the user, the described system provides a technique for generating an avatar to represent the user using images that are within a recency period. Additionally, since the avatar can be dynamically created, the avatar can change as the appearance of the user changes between software platform sessions. Thus, the generated avatar more accurately represents a current appearance of the user. However, like the static images, the described system ensures the privacy of the user is maintained by allowing the user to keep the image capture device deactivated during the software platform session, unlike the conventional techniques that require the user to maintain activation of the image capture device during the software platform session. Thus, the described system provides a technique for representing a user that provides a representation that more accurately reflects a current appearance of a user, while decreasing an intrusiveness of the system and maintaining privacy of the user during the software platform session.

The illustrated example embodiments will be best understood by reference to the figures. The following description is intended only by way of example, and simply illustrates certain example embodiments.

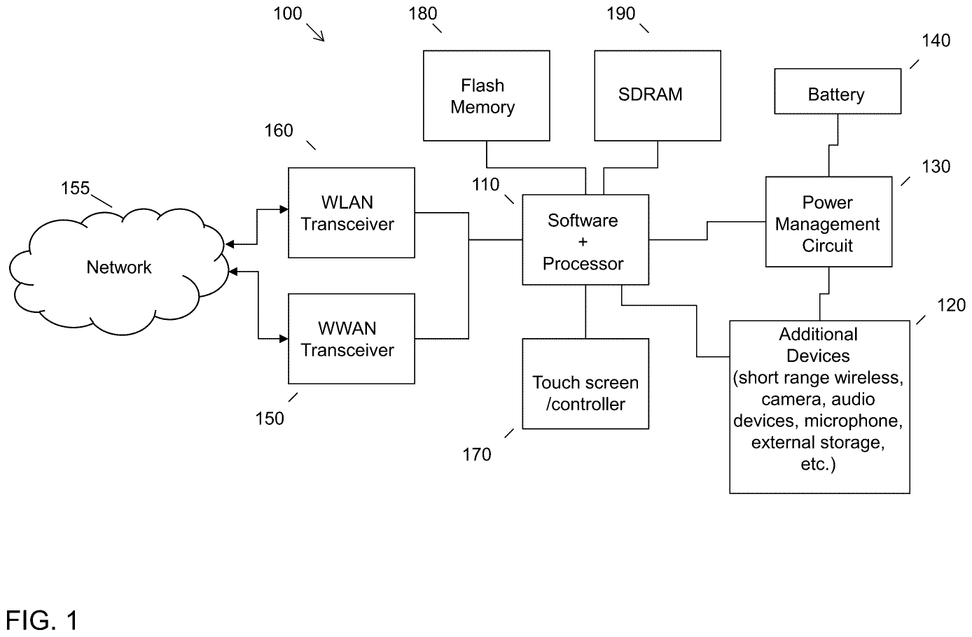

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

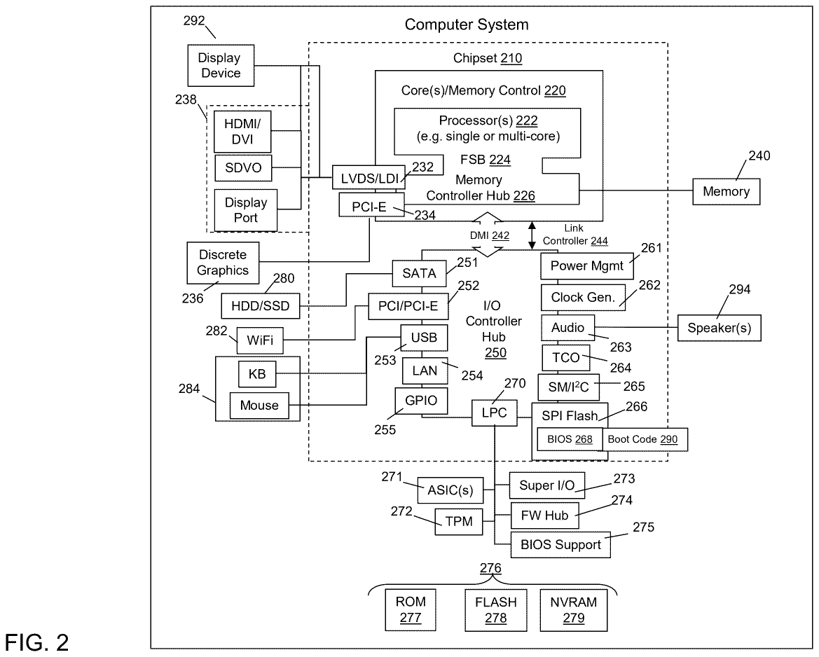

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used to access software platforms that support use of an avatar to represent a user or may be used to capture or store images that can be used to generate the avatar. For example, the circuitry outlined in FIG. 1 may be implemented in a tablet or smart phone embodiment, whereas the circuitry outlined in FIG. 2 may be implemented in a personal computer embodiment.

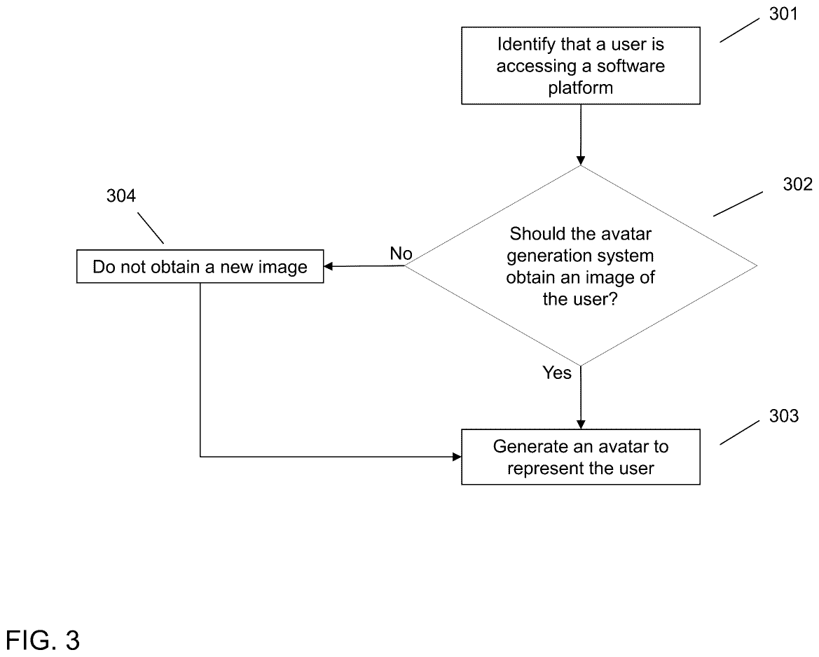

FIG. 3 illustrates an example method for generating an avatar to represent a user within a software platform using a recent image of the user. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to generate an avatar for a user using a recent image of the user. Additionally, the avatar generation system includes modules and features that are unique to the described system.

Accordingly, the avatar generation system may be activated in order to generate an avatar to represent a user in a software platform. The representation may be of a static avatar or a dynamic avatar. For example, the avatar may be utilized to represent a user within a static identifier representing the user within the software session, for example, as a static image avatar in a video conference session or as a static video feed avatar in a video feed of a video conference session. As another example, the avatar may be utilized to represent the user in a dynamic way where the avatar moves while representing the user, for example, as an avatar in a gaming software platform, as a moving avatar within the video feed of a video conference session, and/or the like.

Activation of the avatar generation system may be a manual activation of the avatar generation system and/or an automatic activation of the avatar generation system. Manual activation of the system may include a user opening an application associated with the avatar generation system, the user accessing the computing system associated with the avatar generation system, and/or the user otherwise providing input to the avatar generation system. The automatic activation of the avatar generation system may be based upon the detection of a trigger event indicating that the system should be activated. Example trigger events include a user accessing a software platform that supports display of an avatar to represent the user, detection of a recency timeframe expiring, detection of new images accessible to the system, activation of software or an application utilizing the avatar generation system, and/or the like.

The avatar generation system may be made of multiple systems or modules that communicate together to make up the avatar generation system or may be a single system. The avatar generation system may be a standalone system, may be accessible through other computing devices, and/or a combination thereof. For example, the avatar generation system may be a standalone system that can be accessed by a user and/or may be or provide an application that is accessible by a user on another computing device. The avatar generation system may be accessible using any type of computing device, for example, personal computer, laptop computer, smartphone, tablet, smartwatch, head-mounted display, smart television or other smart appliance, augmented reality device, virtual reality device, and/or the like. Thus, the avatar generation system may be accessible locally using a computing device where the avatar generation system is installed and/or may be accessible remotely through another computing device. For example, the avatar generation system may be accessed by a user using a device that communicates with the avatar generation system to generate avatars for software platforms, access avatar profiles for a user or users and/or software platform(s), access profiles for the avatar generation system, and/or the like. However, the avatar generation system may be located and operate on a different information handling device to perform the described steps.

The generation of avatars can be provided as a service to other entities or companies. In other words, the avatar generation system could be stored on a server or network of a company and the system could generate avatars for other companies or entities, with the other companies or entities paying for the generation of avatars or use of the avatar generation system.

The avatar generation system may have an associated graphical user interface. The graphical user interface may be provided on a display or monitor, which may or may not be associated with the avatar generation system. In other words, the avatar generation system may have a dedicated display or monitor or may be accessible using any display or monitor. In either case, the avatar generation system may provide instructions to generate and display the graphical user interface on the display device being used to access the avatar generation system. The graphical user interface may also be updated and managed based upon instructions provided by the avatar generation system. In other words, the avatar generation system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the avatar generation system. For example, the avatar generation system may utilize a user profile, software platform profile, historical information, avatar profile, and/or the like, to identify when an avatar should be generated by the avatar generation system, when the avatar generation system should obtain images of the user to generate an avatar, what software platforms for which an avatar should be generated, and/or the like. The graphical user interface may allow for creation of or access to these profiles, historical information, and/or the like, by allowing a user to input information regarding user preferences, software platform preferences, image location preferences, and/or the like. As will be discussed in more detail, the use of user provided information is not the only way that the profile and/or historical information can be created. The avatar generation system can then utilize these inputs to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, generated avatars, software platforms and associated avatars or preferences, and/or the like. It should be noted that the information to be used by the avatar generation system and information provided by the avatar generation system can be different for different applications, different computing systems, different users, and/or the like. Thus, the information corresponding to input or output of the avatar generation system are not always the same. However, the avatar generation system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The avatar generation system may utilize one or more artificial intelligence models in generating an avatar to represent a user within a software platform. Artificial intelligence models could be designed to obtain images of the user and determine what images could or should be utilized in the avatar generation, establishing relevancy time periods, generating the avatar from the image, or any other steps within the described system. Artificial intelligence models may also be used for steps within a step. For example, a model could be utilized to perform image analysis to identify images having the user, perform steps of the avatar generation, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the avatar generation system or may be a model that is created from scratch. Since the avatar generation system is used in conjunction with creating avatars for users from images of users, some models that may be utilized by the system are image analysis models, other analysis models, similarity identification models, language models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The avatar generation system may include different components for carrying out different functions of the system, including different steps to be performed. These components may be hardware components or software components. Some hardware devices or components that may be utilized by the avatar generation system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the avatar generation system. For example, the avatar generation system may include speakers, displays or monitors, haptic output devices, audio output devices, and/or the like. Other hardware components may be included to capture images of the user for use in the generation of the avatar, for example, an image capture device, screen capture devices, and/or the like. Other hardware components may include data storage devices, including on devices of the user (e.g., mobile device, personal computer, laptop, tablet, smart watch, etc.), devices or components of the avatar generation system, and/or the like.

Some software components include the user profile that stores information related to the user and user preferences. Within the user profile the user can identify a data storage location from which to obtain images, for example, which data storage locations the avatar generation system is allowed to access, a ranking or preferences of data storage locations for obtaining images, and/or the like. The user profile may also identify which avatars should be utilized for different software platforms, default avatars to be utilized, default recency time periods, and/or the like. The user profile may also identify a recency time period for the user. The recency time period could be different for different software platforms. Thus, the user profile can identify the recency time period for each software platform. The recency time period identifies how recent the images should be with respect to when the user is accessing the software platform. In other words, the recency time period identifies how frequently new avatars should be generated and, therefore, how frequently images should be obtained to generate the new avatars.

While the recency time period can identify how frequently images should be obtained, it is not the only factor that can be utilized to determine if an image should be obtained. For example, the system may also take into account a characteristic of the user, user input indicating new images should be obtained, a frequency of access of a particular software platform, a network connection or device characteristic, a characteristic of the software platform, an indication of the software platform, and/or the like. Some factors may be overriding factors regarding whether an image is obtained, for example, user input indicating the user wants a new avatar to be generated. Thus, the factors may be weighted with respect to whether an image is obtained. Other factors may be aggregated to make a determination regarding whether an image is obtained to generate a new avatar.

The system may also include an avatar profile which stores information related to different avatars or configurations of avatars. The avatar profile may be part of the user profile. The avatar profile may identify the avatars that are used for particular software platforms, include the different avatars that have been generated over time, may include how frequently an avatar has been generated, and/or the like. Another profile is the software platform profile which stores information related to software platforms. The software platform profile may identify which avatars have been generated for the software platform, how frequently a new avatar should be generated for that software platform in the event the software platform has requirements for a frequency of avatar generation, a default avatar for the software platform, and/or the like. All of the profiles in combination or individually may provide information regarding how to obtain an image, from where to obtain an image, when an avatar should be generated, how an avatar should be generated, and/or the like.

At 301, the avatar generation system identifies a user is accessing a software platform that supports display of an avatar to represent the user. The software platform may be any type of platform that does or could represent the user as an avatar. This includes software platforms where the user is solely represented by an avatar, for example, some gaming software platforms, or software platforms where the user can choose to present a live or direct video feed of the user themselves or a video feed of an avatar representing the user, for example, in video call or conferencing software. In other words, the software platform is any software platform that supports a display of an avatar to represent the user.

When identifying the user is accessing a software platform, the system may determine that the user has provided input to open an application, window, tab, and/or the like, associated with the software platform. This may include providing input to an icon of the software platform, selecting a link that opens the software platform, opening another application that utilizes and internally opens the software platform, and/or the like. Thus, the user can perform any action or provide any input that opens or activates the software platform. Once the software platform is accessed, the user may be put into a configuration portion of the software platform. This configuration portion is different for different software platforms, but is generally the portion of the software platform that is presented when the user first accesses the software platform. This portion allows the user to provide input on how the user is presented in the software platform. For example, some software platforms provide an input area for the user to provide a user name, select what output devices are utilized, select what input devices are activated upon activation of the software platform session, and/or the like.

This portion may also allow the user to select whether to be represented by a direct video feed of the user, by an avatar, and/or the like. Alternatively, some software platforms may automatically represent the user as an avatar and the user would not have to select to be represented by an avatar since this is the default or only option. Regardless of how the software platform is configured, this portion of the software platform is the portion of the software platform where the representation of the user is not yet visible to other participants within the software platform. For ease of readability, this portion of the software platform will be considered accessing the software platform, but occurring before a user is entered into or placed within a session of the software platform. The portion of the software platform where a representation of the user is accessible or viewable by other participants within the software platform will be considered the portion of the software platform where a session of the software platform is activated or when the user enters into or is placed within the software platform session.

Stated differently, a session of the software platform is when the video feed of the user is being presented to other users within the software platform. In other words, the user is not considered to be entered into a session of the software platform until other participants, regardless of whether other participants are actually within the session of the software platform, could see the video feed or other representation of the user. For example, a video conferencing session is considered activated once the user is placed within the conference and a video feed of the user is viewable by other users or participants within the video conferencing session. Thus, when the user is within the waiting room or in the set-up portion of the software platform (e.g., when the user is providing input to be used for the participant in the video conferencing session, when the user is configuring the video conference session, etc.), the session of the software platform is not considered to be activated.

At 302, the avatar generation system determines if an image of the user should be obtained. In determining if an image of the user should be obtained, the system may utilize a recency time period. The recency time period corresponds to a time associated with the capture of the image being within a predetermined time frame as compared to a time of the identifying. In other words, the recency time period identifies how recent the image should be as compared to when the user is accessing the software platform. Thus, the system may identify when the image was captured and compare that time/date of capture to the time/date that the user is accessing the software platform. If the difference in time period is less than or equal to the predetermined time frame (i.e., the recency time period), the image would be in consideration for use in generating the avatar. If the time period is greater than the recency time period, the image may be discarded for consideration for use in generating the avatar. It should be noted that images outside the recency time period could be considered for use in avatar generation if the user approves the inclusion of these images, if the system is unable to find any other images of the user, and/or for other reasons.

Images can have multiple timestamps associated with different events corresponding to the image, for example, when the image was captured, when the image was stored in an image source location, when the image was manipulated, and/or the like. The timestamp of interest to the system is the timestamp associated with when the image was captured. If the system is unable to determine when the image was captured, the system may discard the image for use in avatar generation. Alternatively, or additionally, the system may perform additional analysis to determine if the system can determine when the image may have been captured. For example, if the system has access to other images that have a captured timestamp, the system could compare the image having an unknown captured timestamp to the images having a known timestamp and determine if there are similarities that would allow the system to determine the captured timestamp of the image having the unknown captured timestamp.

A length of the predetermined time frame, or recency time period, may vary across users, may vary across software platforms, may vary for different avatars, and/or the like. The length of the recency time period may be stored within the user profile, software platform profile, and/or the like. Accordingly, the length of the recency time period can be a default value, selected by the user, selected by a software platform, learned and selected by an artificial intelligence model, and/or the like. As an example of an artificial intelligence model providing an output related to a length of the recency time period, the artificial intelligence model may learn how frequently a characteristic or appearance of a user changes and then make the length of the recency time period match this frequency of change. As another example, a model can learn how often a user wants a new avatar to be generated, and then make the length of the recency time period match this user preference. As can easily be understood, a model could be used to learn many different factors and then modify the length of the recency time period based upon this learning.

Additionally, the recency time period can be dynamic and change based upon different factors, for example, preferences of the user, characteristics of the user (e.g., a change in appearance as compared to the previously generated avatar, a particular change in appearance of the user, etc.), a software platform, an output of an artificial intelligence model, and/or the like. A change in appearance may be a change in facial accessories (e.g., glasses, piercings, contacts, etc.), a change in facial hair, a change in hairstyle (e.g., color, cut, length, texture, etc.), a change in tattoos, a change in clothing or other garments, and/or the like.

In addition to the recency time period, whether the system obtains an image based upon other factors, for example, a characteristic of the user, user input indicating new images should be obtained, a frequency of access of a particular software platform, a network connection or device characteristic, a characteristic of the software platform, an indication of the software platform, a number of images that are within the recency time period being less than a predetermined threshold number of images needed to generate an avatar, and/or the like. Characteristics of the user may include a change in appearance that is detected by the avatar generation system, a change in appearance of the user that matches a condition identified by the user (e.g., the user identifies that certain appearance changes should trigger generation of a new avatar, the user identifies that a certain number of appearance changes should trigger generation of a new avatar, the user identifies that an appearance change exceeding a similarity threshold should trigger generation of a new avatar, etc.), a change in appearance of the user as compared to a previously generated avatar, and/or the like.

The user may also provide input indicating that a new avatar should be generated. For example, when the user accesses the software platform, but before the user enters or is placed within a software platform session, the user could provide input indicating the user wants to change the avatar that is currently being used for the software platform. In other words, even if the recency time period would indicate that an image should be obtained, other factors may prevent or discourage the system from obtaining an image. For example, a network connection or device characteristic may influence whether the avatar generation system obtains an image because the network connection, characteristics of the network connection, or device characteristics may not be favorable to obtaining images. For example, if the images are stored on a secondary device (i.e., a device that is not being utilized to access the software platform) and the network connection is weak or the bandwidth of the network connection is small, the network connection may not allow the avatar generation system to obtain the image.

Similarly, even if the recency time period would indicate that an image does not need to be obtained, other factors may cause the system to obtain an image. For example, a user may provide input indicating that a new avatar should be generated for the user for this access to the software platform. These are merely examples as other factors or examples can cause the system to obtain an image when the recency time period would not cause the obtainment of images or cause the system to not obtain an image even when the recency time period would cause the obtainment of images.

The system may obtain an image from an image source location on the device the user is utilizing to access the software platform, from an image source location associated with the user, and/or from any image source location accessible by the avatar generation system. The image source locations that the system can access may be identified within the user profile. Additionally, if the system needs any credential information, links to locations of image source locations, and/or the like, to access an image source location, this information may also be included in the user profile. Alternatively, or additionally, the user could provide this information when the user first access the software platform and requests an avatar to be generated. The provided information can then be stored in the user profile for subsequent user.

Image source locations may include, but are not limited to, camera rolls, photo storage applications, social media websites, activation of an image capture device, user accounts, file storage locations, and/or the like. For example, the system may access a social media website and an account of the user or images including tags corresponding to the user and obtain the images that include the user. As another example, the system may request that the user activate an image capture device to capture images of the user after the software platform has been accessed. This may occur if the system cannot access any other image source locations, the images of the user within the other image source locations are not within the recency time period, the user has indicated that images from other image source locations should not be used, the system is unable to generate an avatar from the images within the other image source locations, the system is unable to get enough images from the other image source locations, and/or the like.

Thus, one image source location may be requesting or prompting the user to provide the image via activation of the image capture device or by uploading an image from a source that is not accessible to the avatar generation system, particularly if the system is unable to obtain an image or enough images that are within the recency period. For example, the system may identify a number of images of the user is less than a predetermined threshold number of images within the recency time period and then prompt the user to provide an image, either via uploading an image or by prompting the user to activate the image capture device so one or more images can be captured and obtained by the system. However, the system may request or prompt the user to provide an image regardless of the recency period or accessibility of other images that can be obtained by the system. In requesting or prompting the user to provide an image, the system may request or prompt the user to activate an image capture device that is accessible by the avatar generation system, request or prompt the user to upload an image that may be located at an image source location that is not accessible by the avatar generation system, and/or the like.

The system may access the image source location and identify images that are of or that include the user. To identify these images, the system may perform image analysis, using an image analysis technique, an artificial intelligence model, and/or the like, to analyze the image and identify the user within the images. In performing the image analysis, the system can compare entities recognized within the images to known images of the user to identify those images including the user. In other words, the system may identify, from a number of images, those images that contain the user and potentially utilize these images in the avatar generation.

If the system determines that the avatar generation system does not need to obtain an image of the user at 302, the system may not obtain a new image at 304. The system may determine that an image does not need to be obtained if a previously presented avatar was generated within a predetermined time period as compared to the time when the user is accessing the software platform. The system may also determine that an image does not need to be obtained if the user provides input indicating that a new avatar does not need to be generated. For example, the user may indicate that the video feed of the user will be active through the entirety of the software platform session. As another example, the user may override the need to obtain a new image by indicating a previously generated avatar should be created, by indicating that the recency time period needs to be lengthened, and/or the like.

Thus, the user may provide input to indicate that the avatar generation system should not generate a new avatar for the user. In other words, the user can provide input to the system indicating that the system should utilize a previously generated avatar. The user could indicate which previously generated avatar should be utilized to represent the user, for example, as input during the software platform set up, within the user profile, and/or the like. For example, if the user indicates that a previously presented avatar should be utilized, the system may present a number of previously generated avatars and request the user select one to be utilized during the software platform session. As another example, the user could identify, within the user profile, a default avatar that is automatically utilized unless the user indicates otherwise. Alternatively, the system may select a previously generated avatar without input from the user. The system selection may include the most recently generated avatar, the most commonly used avatar, a specific avatar for particular software platforms, and/or the like.

Even if the system does not obtain a new image of the user, the system may generate an avatar to represent the user at 303. In this case, generating an avatar may include selecting a previously generated avatar to represent the user within the software platform session. In other words, the system may not generate a new avatar or generate an old avatar, but rather select an old or previously generated avatar for the user. In the case that a previously generated avatar is not available, the system may request the user to make a selection regarding what should be displayed during the software platform session, for example, a static image, a static identifier, a live video feed, and/or any other type of traditional representation.

If, on the other hand, the system determines that the avatar generation system does need to obtain an image of the user at 302, the system may obtain the image (or set of images) as discussed, and generate, from the obtained images an avatar to represent the user within the software platform at 303. The avatar may be a computer-generated illustration that bears at least some resemblance to the user. The avatar is generated from the obtained image(s) and before the user enters into a session of the software platform. In other words, the avatar is generated before the user is placed into the session of the software platform. The generation of the avatar may be performed after the image capture device is deactivated. For example, if the user was prompted to turn on the image capture device in order to obtain images of the user, the user could turn off the image capture device before or while the avatar is being generated.

Regardless of whether the image capture device is active or deactivated when the avatar is generated, the avatar is generated before the user enters into a session of the software platform session, thereby allowing the user to deactivate the image capture device or keep the image capture device deactivated while the user is within the software platform session. The software platform session may be already be started by the time the user enters or is placed into the session. For example, if the user is not the leader the software platform session may start when the leader activates the software platform session. Thus, by the time the user enters the software platform session, it may have already been activated. As another example, if the user is late to the meeting or video conference, the software platform session may already be started by the time the user accesses the software platform session. The software platform session may also be activated when the user enters into or is placed within the software platform session, for example, if the user is the leader of the session, if the user is placed into the session at the time of activation of the session, and/or the like. Thus, the generation of the avatar may occur before the user has entered or has been placed into the software platform session, regardless of when the software platform session has been activated.

Generating the avatar may be performed using techniques for generating an avatar. Generally, the steps for generating an avatar may include utilizing image preprocessing techniques to prepare the obtained two-dimensional (2D) images for three-dimensional (3D) modeling. For example, the image preprocessing techniques may include face detection, image resizing, color correction, noise reduction, and/or the like. The system may then perform 3D face reconstruction that estimates the 3D shape and texture of the person's face based upon the obtained images. Texture mapping may then be performed to apply the textures and details from the 2D photos onto the 3D model. The system will then perform rigging where a virtual skeleton will be added to the 3D model to allow animated facial expressions and movement. The avatar is then generated and is ready to be integrated into the software platform, meaning it can be displayed within the software platform session and can even be animated or move within the software platform session. It should be noted that other steps and/or techniques, including fewer or more steps, can be utilized for generating the avatar.

Once the avatar is generated, the system may display the avatar to the user before the avatar is displayed within the software platform session. The system may request that user provide input regarding the avatar before it is displayed within the session. For example, the system may request that the user provide input approving the avatar before it is displayed within the session. As another example, the system may allow the user to provide input to make changes to the avatar before it is displayed within the session. Once the user has provided the requested input, the system may display the avatar within the software platform session. Alternatively, the system may not request any input from the user regarding the avatar and instead display the generated avatar within the software platform session once it has been generated.

As an overall non-limiting example of the described system, a user accesses a video conferencing software platform where a video feed of the user is provided to other participants within the video conference. The user can choose the type of video feed to provide (e.g., static image, avatar, dynamic avatar, direct video feed of the user, etc.) and chooses to be represented by an avatar within the video conference. While the user is within the set-up stage of the video conference (i.e., before the video conference session is activated), the system receives an indication that a new avatar should be generated for the user. The system accesses a camera roll of the user to obtain some recent images of the user. The system may also access a social media account of the user to obtain other recent images of the user. The obtained images are within the recency time period that has been identified for the user. In this example, the recency time period for this user will be the last 30 days. From the images that the system obtains, the system generates an avatar of the user that represents the user. In other words, the system is able to generate an avatar of the user that looks like the user has looked within the last 30 days. This avatar is then presented in the video feed of the user when the session is activated and the user can keep their camera off during the session.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more”unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using an avatar generation system, that a user is accessing a software platform that supports display of an avatar to represent the user;
obtaining, using the avatar generation system, an image of the user, wherein a time associated with a capture of the image is within a predetermined time frame as compared to a time of the identifying; and
generating, from the image and before the user enters into a session of the software platform, an avatar to represent the user within the software platform.

2. The method of claim 1, wherein the obtaining comprises accessing a image source location.

3. The method of claim 1, wherein the obtaining comprises identifying, from a plurality of images, at least one image containing the user.

4. The method of claim 1, wherein the obtaining comprises prompting the user to capture an image upon accessing the software platform.

5. The method of claim 1, wherein the obtaining is responsive to detection of a change in a characteristic of the user as compared to a previously generated avatar.

6. The method of claim 1, wherein a length of the predetermined time frame is based upon a characteristic of the user.

7. The method of claim 1, wherein a length of the predetermined time frame is dynamic and based upon preferences of the user.

8. The method of claim 1, wherein the obtaining is responsive to identifying that a number of images of the user within the predetermined time frame is less than a predetermined threshold and prompting the user to provide the image.

9. The method of claim 1, wherein the generating is performed after an image capture device is deactivated.

10. The method of claim 1, further comprising displaying the avatar to the user and requesting input from the user regarding the avatar before display within the software platform session.

11. A system, the system comprising:
a processor;
a memory device that stores instructions that, when executed by the processor, causes the system to:
identify, using an avatar generation system, that a user is accessing a software platform that supports display of an avatar to represent the user;
obtain, using the avatar generation system, an image of the user, wherein a time associated with a capture of the image is within a predetermined time frame as compared to a time of the identifying; and
generate, from the image and before the user enters into a session of the software platform, an avatar to represent the user within the software platform.

12. The system of claim 11, wherein the obtaining comprises accessing a image source location.

13. The system of claim 11, wherein the obtaining comprises identifying, from a plurality of images, at least one image containing the user.

14. The system of claim 11, wherein the obtaining comprises prompting the user to capture an image upon accessing the software platform.

15. The system of claim 11, wherein the obtaining is responsive to detection of a change in a characteristic of the user as compared to a previously generated avatar.

16. The system of claim 11, wherein a length of the predetermined time frame is based upon a characteristic of the user.

17. The system of claim 11, wherein a length of the predetermined time frame is dynamic and based upon preferences of the user.

18. The system of claim 11, wherein the obtaining is responsive to identifying that a number of images of the user within the predetermined time frame is less than a predetermined threshold and prompting the user to provide the image.

19. The system of claim 11, wherein the generating is performed after an image capture device is deactivated.

20. A product, the product comprising:
a computer-readable storage device that stores executable code that, when executed by a processor, causes the product to:
identify, using an avatar generation system, that a user is accessing a software platform that supports display of an avatar to represent the user;
obtain, using the avatar generation system, an image of the user, wherein a time associated with a capture of the image is within a predetermined time frame as compared to a time of the identifying; and
generate, from the image and before the user enters into a session of the software platform, an avatar to represent the user within the software platform.
